(19) United States
(12) Patent Application Publication
(10) Pub. No.: US 2003/0191702 A1
(43) Pub. Date: Oct. 9, 2003

(54) Asset backed debt consolidation

(76) Inventor: William J. Hurley, Manchester, NH (US)

Correspondence Address: William J. Hurley, 95 N. River Rd. Apt. 12, Manchester, NH, 03104, US

(21) Appl. No.: 10/026,028

(22) Filed: Apr. 9, 2002

(51) Int. Cl. G06F 17/60

(52) U.S. Cl. 705/36

(57) ABSTRACT

A hybrid interactive process by which a loan and investment transition a customer from debt to a savings account. Debt repayment is structured by utilizing multiple monthly payment streams to combat compounding interest as it works against a person carrying debt. The investments provide a two tiered portfolio as collateral in the event of unforeseen client emergencies using bonds or bond mutual funds. Growth in stocks or stock mutual funds is used to retire outstanding debt with a continuing transition solely into investing as a progressive process to achieve a customer's stated financial goals.

The use of credit cards and the low savings rate in the United States have reached unparalleled levels. Eighteen percent of disposable income now goes to service consumer debt while we save less than two percent of our disposable incomes. 1 Yet most Americans keep spending. Bankruptcies have risen 400% since 1980-1998 during fairly sound economic times. Unemployment has been low and incomes have been keeping pace with inflation. If unemployment and inflation rise, where then will bankruptcies and non mortgage debt head?

What if there was a way to reverse those savings and debt numbers, even just slightly, with one program? After roughly five years of developing this plan and observing the multitude of mortgage related debt consolidation programs, bill pay services, credit card transfer and consolidation offers, you'd think the national averages on debt and savings would have started to reverse by now. They haven't.

What if there were also a way to collaterallize or escrow a debt to savings and investing program to ensure payments will continue to the new loan in the event of extenuating circumstances without putting real estate at risk or having to buy an insurance policy? What if a customer who had the ability and desire to repay his obligations could be transitioned into a savings and investing program upon completion of this loan program repayment phase? Currently, I suspect most consumers simply use their savings from existing debt relief programs to achieve new levels of spending. Do most homeowners even use the equity in their homes for debt consolidation?. After all our government is dependent on the consumer spending for ⅔ of the US economic stimulus. They have also made savers suffer through complex tax forms.

What if there was a program that could capture those debt consolidation dollars with collateralization, turning a spender on credit into a saver and investor, with compound interest working for instead of against them? What if also, this program contained an escrowed attachment of a money market mutual fund equal to at least three months of the loans monthly payment to secure the lender against default?

The US stock market has averaged roughly 9-11% historically. What if that power were coupled into this new debt elimination strategy that added conservatively, $0.07 or $0.08, after taxes, to every dollar that goes to pay down the loan portion of this plan to accelerate the payoff period? What if a bi-weekly loan payoff program were added to accelerate the process further?

Then, when the loan portion of this plan was complete, a notification of debt obligation satisfaction were sent to the customer along with a debit card attached to the money market mutual fund sided by a continuation of investing in the growth oriented mutual finds already established?

I imagine there might be some consumer demand for this program. Can it be implemented profitably and safely for investors and company organizers alike? Can all parties win in this debt to savings initiative? Where else in the financial world is anyone combining a savings component with another under one roof? Cash value insurance for one, brokerage accounts for another. It can be done. Ultimately, could this debt and investing bundling be done in a way that will reverse the savings trend to those who have the desire to do so?

The details are as follows:

A customer with debt would like to transition that money into an eventual down payment on a home, an IRA, college fund or whatever the goal may be. He or she comes to my company and agrees to a new plan that does not

A. put real estate at risk

B. ask them to pay any fees to a debt pay down program that a yellow pad and common sense could do for them.

C. negotiate with creditors for a fee to lower payments.

D. get a lawyer involved for more fees putting a mark on your credit for 7 years in bankruptcy.

This new program is intent on saving our customers money on a monthly basis form where they were. The contract or paper work contains three components.

1. A new loan made up of simple interest and bi-weekly payments.

2. Money market and tax sensitive growth oriented mutual funds.

3. Collateralization, escrow and payments transferred legalities linking the loan with the investments.

This would work similar to a brokerage account where a core money market mutual find sweeps money to and from the loan account and stock mutual fund or to a cash value life insurance policy that uses cash accumulation to pay its insurance components. Unlike cash value insurance, the objective of my program is not intended to keep you reeling in its main money making component, the loan. In their case, the insurance. It's intent is to simplify the customers financial lives with one new payment to my company. We handle the intricacies of channeling the money from there. All banking and securities regulations must be complied with and customers will be educated to the total process with involvement to the extent the wish to be. Statements must be generated with total cost of the loan and payoff target dates along with investment performance and relevance (prospectuses, etc.) Tax efficiency must be highly prioritized as this program will be in taxable accounts until we can start our customers in IRA's should they choose.

The consolidation loan would need to be amortized over a ten year period in order to free up the initial savings necessary to begin the collateralization process while simultaneously saving the customer money on a monthly basis. We are fully aware that there are numerous credit card companies offering balance transfers at lower interest rates. But, their payoff periods are uncertain. Their objective is simply to build your debt with them, not a strategy to become debt free.

In my proposed plan, the payoff is set for ten years but intended to be completed in years five to seven depending on the underlying after tax performance of the stock and bond mutual funds. The customer will remain informed throughout the process. Once the loan payoff is achieved, the customer would then have the money that was going to service the debt transitioned to investing and saving in the accounts already established with the opportunity to make these funds IRA's, Roth or regular.

### EXAMPLE

A client has $10,000 in non mortgage revolving debt, not uncommon but a little higher than the national average of $7000 on 5 credit cards. They apply for a new ten year loan with a laddered down and or low incentive to join interest rate. They then set forth to sign paper work for a loan at say 10% simple interest of $132.16 per month or $66.08 every two weeks. At 3% of outstanding balances owed, their old payments to credit cards could have been $300 per month on $10,000 with no end in sight and very little money being applied to its principle.

Therefore, a savings has been generated to the customer of roughly $170 per month. With this savings we need to first start generating an emergency fund to keep our default ratios low. A secured status need not be fully attained up front unless consumer credit scores reveal such a risk. $100 per month could now go to a money market mutual fund monthly until 3-6 months of reserves are established. These reserves will be held by us throughout the repayment process until the loan is satisfied where the money market fund will revert back to the customer. The emergency fund could be activated to make a payment during the holidays to keep our customers out of the debt trap. Total new payments to the customer are $232.16 per month. They will save about $68 per month with no fees or closing costs. The customer has one payment and more importantly, the dignity of repaying their obligations in an intelligent fashion. Character and collateral should mean something again.

Once the emergency fund is secured, the $100 per month that was going to the money market fund now can be channeled to tax managed growth oriented mutual funds like index funds. $100 per month at 8% would grow to approximately $7347.64 before taxes after 5 years. If $7000 after taxes were coupled with the continuing loan repayments for 5 years equaling $8100. $15,100 would now be available to satisfy the loan with profit after paying off the original $10,000 loaned to the customer. Payoff periods could be shorter or longer depending on the programs expenses and performance of the underlying mutual funds and any extra payments by the customer.

In transitioning to the new savings and investing program after loan payoff, an IRA can be opened for the customer. At 8% for the next 5 years the customer could have as much as $7347.69 in their accounts at $232 per month that was going to the loan payoff. With a home equity loan the customer is likely still in debt at year 5 and the credit card process would be on going with interest payments far exceeding the $5100 in this example.

The consumer appetite for spending would not go away in this or any other program however, we just took $10,000 of credit card debt and turned it into $7000 of savings in ten years for that particular debt. As in brokerage accounts, debit cards and check writing then can be used to access your money in your new money market account encouraging the use of cash over credit. We are attempting to replace the negative compounding interest treadmill with hope.

It is my understanding that regulation T allows for this type of collaterallization but only to 50% of a securities accounts' value, but is encouraged when savings accounts are used as collateral from banker publications I have seen. Real estate uses an escrow account. Cash value accumulates in life insurance policies. My proposal utilizes a little of each of these techniques. There is a huge pile of money out there working against people instead of for them. October 1998 showed a negative savings rate in the US and continues through 1999. Yet there are over 10,000 mutual funds, 2000 insurance companies and plenty of good banks and credit unions available to Americans. Is debt more profitable than saving? I have attempted to make savings from debt profitable for all.

Some tax laws continue to discourage saving and investing. The government is not helping things as ⅔ of economic activity is dependent on the consumer spending and not saving. By the year 2020 one estimate puts 60% of the federal budget being tied up with retirement programs for the spendthrift baby boomers whom are slated to retire with only a few thousand dollars at their current savings rate. To some who do save and invest, they jump in and out of financial products to the delight of the fee based systems prevalent in our financial system hurting customers' returns. This proposal would address loyalty and structurally we would gear ourselves to get paid based on an improved net worth of our customers we serve contrary to the bankers, lenders who have hurt their customers finances to a greater extent than they will ever know pushing credit instead of disciplined savings.

An objection might be: Why would anyone not take any savings from a consolidation loan and apply it directly to the principle on their own? Yes, they can. With my program, extra money will be applied to principle coupled with earnings from the collateralized funds at 3%-10%. Is applying $1 or $1 and $0.03-$0.10 compounded toward principle better. How many people actually pay down their loans in this way? How many people pay their loans off early? Captively, 100% of my customers will without tying up their real estate or lowering their credit scores by jumping from credit card to credit card after which you are at their mercy as they raise interest rates and fees. We will attempt to utilize our customers investment skills with ours to coordinate their getting out of debt time frame. Debt is the number one financial concern to those that care about their futures. Why not tackle debt first. The financial companies are scraping with each other for new business. It's out there. It just needs a reshuffle. That is what Asset Backed Debt Consolidation will do.

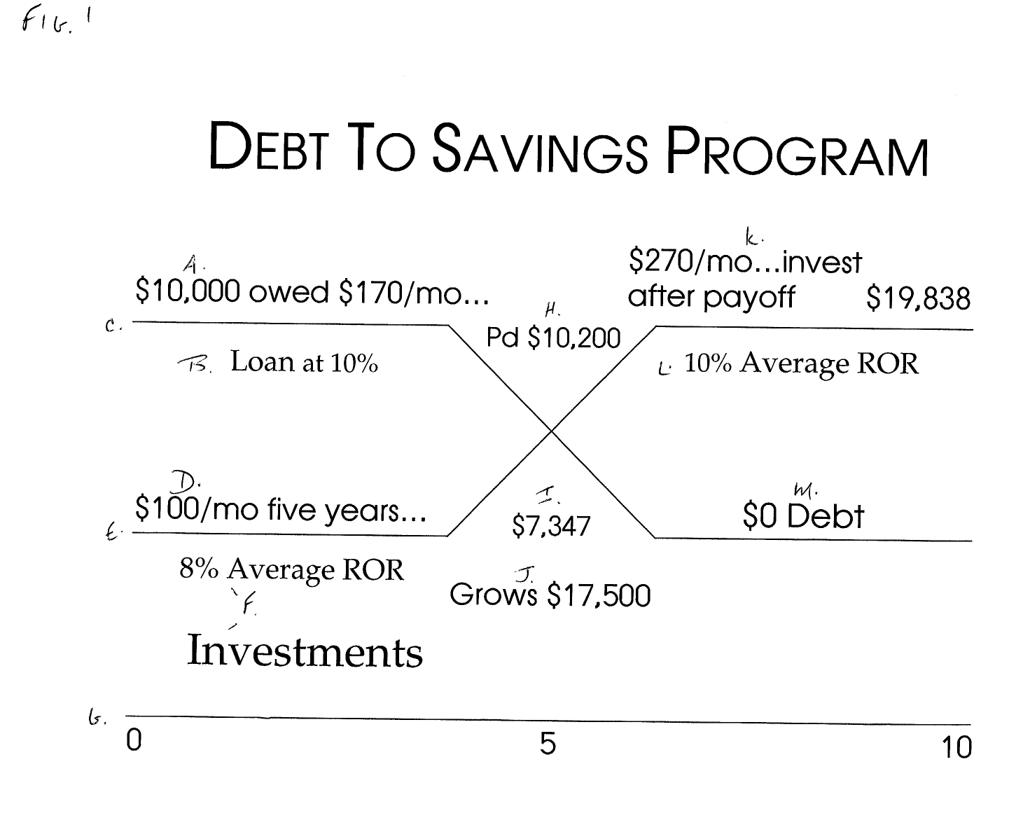

FIG. 1

FIG. 1 is an example of a customer with $10,000 in debt to illustrate how my program works. Numbers shown are interchangeable as to reflect each situation.

A. Represents program example whereby new payment of $170 per month with $10,000 owed in a new consolidation loan with this program.

B. Represents example of new loan at ten percent annual percent rate which is interchangeable relative to circumstances.

C. Represents descending line, the loan, as referenced by A. and B. above.

D. Represents savings generated from consolidation loan from A. and B. above which will be captured in this program to be directed toward investing used as collateral and to accelerate the debt elimination process. $100/Mo five years is one hundred dollars invested monthly for five years.

E. Represents ascending line for investments to grow.

F. Represents investments as referred by D. and E. above. 8% ROR is an eight percent Rate of Return assumed in the first five years.

G. Represents time line in years. Begins with zero, five in the center and year 10.

H. Represents amount of loan payments made after five years Pd $10,200 is $170 per month for sixty months.

I. Represents amount of investment payments made after five years with an 8% annual growth rate compounded monthly factored in. In this example, $100/month at 8% grows to $7347.

J. Represents the sum of loan and investments added together after five years. In this example, $10,200 plus $7347 Grows to a combined total of roughly $17,500.

K. Represents amount of captured dollars per month now directed to investing solely of $170 plus $100 per month is now $270 per month after loan is paid off which now grows to $19,838 assuming a 10% rate of return in as referred to in L.

L. Represents 10% average annual Rate of Return to grow customers money.

M. Represents intended consequence of zero debt after five years and no more carrying forward to year 10.

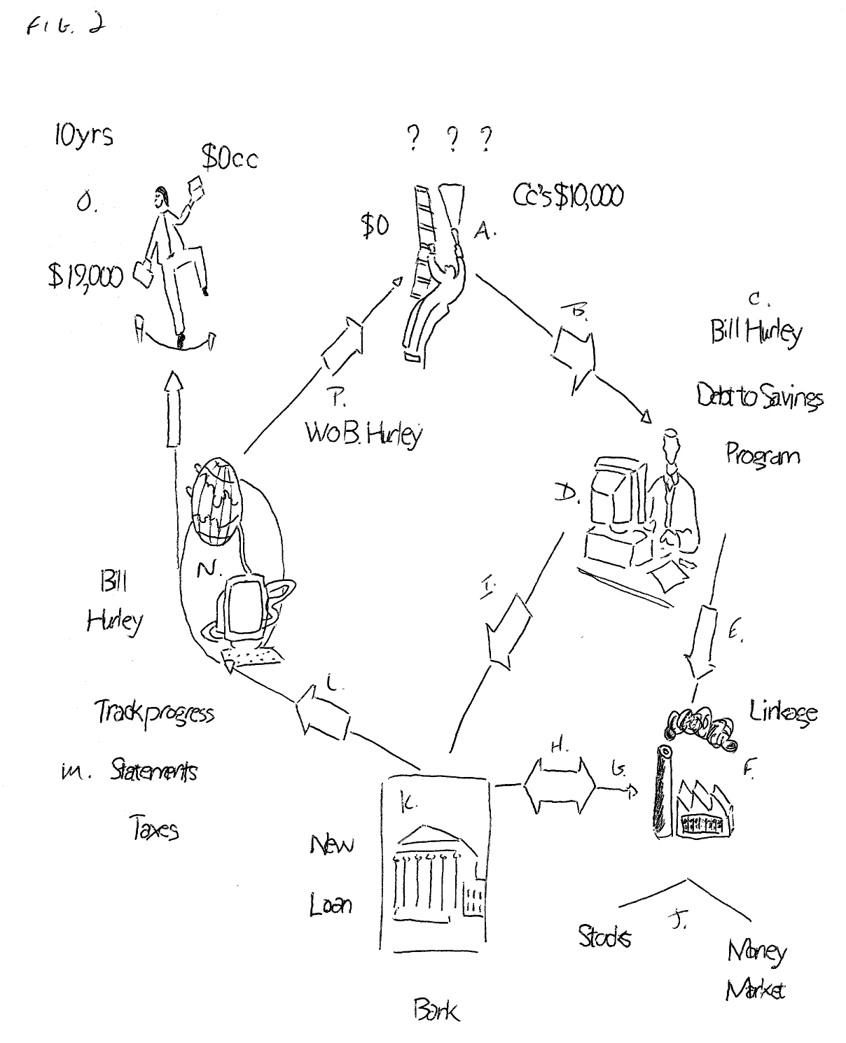

FIG. 2.

FIG. 2 illustrates my proposed method in a flow cycle in animated pictures.

A. Represents person looking for answers with a flashlight looking upward holding $10,000 in CC's (credit cards) debt

B. Represents direction to find answers moving to Debt To Savings Co.

C. Represents Debt To Savings Program and me, Bill Hurley.

D. Represents C. in image at my computer.

E. Represents Debt To Savings Program being directed to industry with links forthcoming in J., G. and H.

F. Represents a factory as an image for industry and linkage forthcoming in J., G. and H.

G. Represents linkage formed between new loan and industry and the interchangeability in order to establish securitization and acceleration

H. Represents interchangeability between loan and investments.

L. Represents new clients money being directed to new loan for consolidation.

J. Represents linkage between stocks and money market mutual funds shown in F.

K. Represents bank where new loan will be serviced in order to consolidate old expensive loans and credit card debt

L. Represents direction of the results from D. through K. heading toward service outlet.

M. Represents a compilation of L. and N. and maintenance operations tracking progress, statement generation, tax ramifications.

N. Represents computer housing for service and maintenance.

O. Represents happy customer after 10 years with $19,000 in investments and zero credit card debt.

P. Represent without (WO) Bill Hurley and Debt To Savings and the arrow heading back to A. looking for answers.

1. I claim a method or process whereby an investment inclusive of a stock, bond or mutual fund is used in combination with a loan for the purpose of debt elimination and net worth improvement as one financial product.

2. I claim the use of dividends and capital gains from investments in a securitization method whereby they are used to pay a consumer loan through a linked system either electronic or by mail.

3. I claim a method whereby incremental improved net worth is a means by which a company engaged in business for profit is financially rewarded through the use of a legal Securities and Exchange Commission approved asset increased process in combination with legal banking department escrow and delayed payments in order that a customer must improve their improved net worth results first.

4. I claim a method either electronic or by mail whereby multiple monthly payment streams are used to pay a consumer loan and investment hybrid net worth improvement product off as quickly as possible to lower a customer's cost of borrowing.
